(19) United States
(12) Patent Application Publication
(10) Pub. No.: US 2009/0244616 A1
(43) Pub. Date: Oct. 1, 2009

(54) PRINT MANAGEMENT SYSTEM USING A BILLING CODE

(75) Inventor: Kazunori Kato, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/411,527

(22) Filed: Mar. 26, 2009

(30) Foreign Application Priority Data
Mar. 26, 2008 (JP) 2008-080478

(51) Int. Cl. G06F 3/12

(52) U.S. Cl. 358/1.15

(57) ABSTRACT

A print management system includes an image processing apparatus and a server that manages a print log of a print document processed by the image processing apparatus. The image processing apparatus includes a designation unit configured to designate a billing code of the print document, and a transfer unit configured to transfer the billing code designated by the designation unit and image data generated from the print document to the server. The server includes a determination unit configured to determine a log level of the print log that stores the print document based on the billing code received from the image processing apparatus.

### BACKGROUND OF THE INVENTION

1. Field of the Invention

The present invention relates to a management system that manages print documents. More specifically, assigning a print log level to a billing code of a print document and managing history information of the print document.

2. Description of the Related Art

The widespread use of digital multifunction peripherals (MFPs) has allowed any user to easily print, copy and transmit documents, and thus has improved user-friendliness. However, such wide spread use has also lead to a demand for security management to prevent leakage of information when printing, copying, and transmitting confidential documents.

In response to such a demand, there is a document management system which stores read image data and text data as a job log along with normal bibliographic information of a document in a storage device when the document is printed, copied, and transmitted by a facsimile or an e-mail, (refer to Japanese Patent Application Laid-Open No. 2002-149371). The job log includes information such as a computer/terminal name, a name of a user who performed printing on a client terminal, a printer name, printed time, and a print job name.

As a result, if there is a document whose information is leaked, an administrator can trace which printer or digital MFP performed when and what type of process by confirming the stored job log.

Further, in order to retain capacity of a storage device of a server that ultimately stores the data, it is desirable to minimize a size of the above-described image data to be stored in the storage device. Therefore, conventionally, resolution of image data is reduced before storing the image data in a history management server, according to a setting of the entire system or a setting for each user and the capacity of the storage device of the server is secured.

Further, in recent years, more users have become print cost-conscious. For example, since a law firm charges a client for printing costs related to the client, there is a demand to separately calculate the print costs for each client, job content, and document type. To respond to such a demand, there is a system that stores and manages print history data including print purposes (Japanese Patent Application Laid-Open No. 2001-92617). As a result, costs can be calculated for each print purpose.

In such a conventional management system, print history can be recorded associated with a print purpose, i.e. what type of document was printed for which client during what kind of operation.

Further, image data and text data can be stored as print history information.

Further, when image data and text data are stored as history information in a storage device of a management server, there is a limit to an area for storing historical data secured in the storage device. Therefore, it is not practical to record history of all print jobs in full-color and high resolution in the storage device.

### SUMMARY OF THE INVENTION

An embodiment of the present invention is directed to a method for assigning a print log level to a billing code of a print document and managing history information of the print document according to the assigned print log level.

According to an aspect of the present invention, a print management system includes an image processing apparatus and a server that manages a print log of a print document processed by the image processing apparatus. The image processing apparatus includes a designation unit configured to designate a billing code of the print document, and a transfer unit configured to transfer the billing code designated by the designation unit and image data generated from the print document to the server. The server includes a determination unit configured to determine a log level of the print log that stores the print document based on the billing code received from the image processing apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a management system according to an exemplary embodiment of the present invention.

FIG. 2 is a block diagram illustrating a configuration of processing units in a digital MFP and an image processing server illustrated in FIG. 1.

FIG. 3 illustrates an example of a user interface (UI) displayed on an operation panel of the digital MFP illustrated in FIG. 1.

FIG. 4 illustrates an example of a UI displayed on the operation panel of the digital MFP illustrated in FIG. 1.

FIG. 5 illustrates an example of a user-content recording format setting table that stores content recording formats for each user, managed by the image processing server illustrated in FIG. 1.

FIG. 6 illustrates an example of a code-content recording format setting table that stores content recording formats for each code, managed by the image processing server illustrated in FIG. 1.

FIG. 7 illustrates an example of a UI displayed on an administrator personal computer (PC) illustrated in FIG. 1.

FIG. 8 is a flowchart illustrating a data processing procedure in an information processing apparatus according to an exemplary embodiment of the present invention.

FIG. 9 is a flowchart illustrating a data processing procedure in an image forming apparatus according to an exemplary embodiment of the present invention.

FIG. 10 is a flowchart illustrating a data processing procedure in an image forming apparatus according to an exemplary embodiment of the present invention.

FIG. 11 is a flowchart illustrating a data processing procedure in an image forming apparatus according to an exemplary embodiment of the present invention.

FIG. 12 is a flowchart illustrating a data processing procedure in a management server according to an exemplary embodiment of the present invention.

FIG. 13 is a flowchart illustrating a data processing procedure in a management server according to an exemplary embodiment of the present invention.

FIG. 14 illustrates a memory map of a storage medium which stores various data processing programs that can be read by an image forming apparatus according to an exemplary embodiment of the present invention.

FIG. 15 illustrates a memory map of a storage medium which stores various data processing programs that can be read by a management apparatus according to an exemplary embodiment of the present invention.

FIG. 16 illustrates a memory map of a storage medium which stores various data processing programs that can be read by an information processing apparatus according to an exemplary embodiment of the present invention.

### DETAILED DESCRIPTION OF THE EMBODIMENTS

Various exemplary embodiments, features, and aspects of the invention will be described in detail below with reference to the drawings.

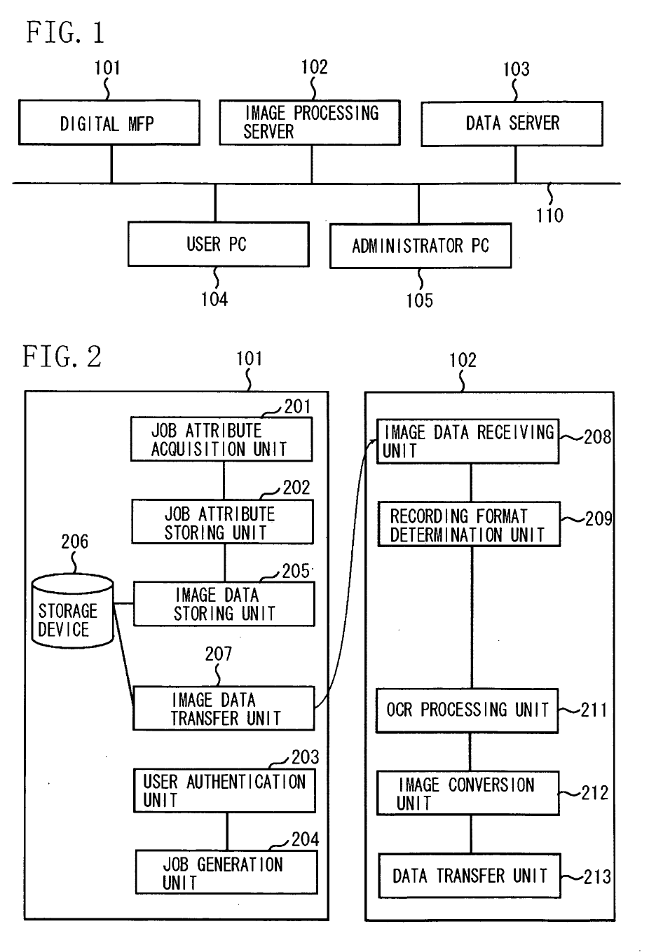

FIG. 1 is a block diagram illustrating an example of a management system according to an exemplary embodiment of the present invention. Referring to FIG. 1, a digital MFP 101, an image processing server 102, a data server 103, a user PC 104, and an administrator PC 105 are connected to a network 110 in the management system. The user PC 104 functions as an information processing apparatus.

The digital MFP 101 includes functions of scanning, printing, copying, and transmitting e-mails and facsimiles. When the digital MFP 101 outputs and executes a job, the digital MFP 101 also generates electronic image data of the job. The digital MFP 101 stores the generated image data together with job attributes that correspond to an input print document in a storage device of the digital MFP 101. Further, the digital MFP 101 transfers the job attributes and the image data to the image processing server 102 at regular intervals.

The image processing server 102 converts the image data transferred from the digital MFP 101 to a format for storing in the data server 103. If a code is set to the image data as the job attribute, the image processing server 102 performs a color conversion, a resolution conversion, and an optical character recognition (OCR) process on the image data according to the content data recording format set to the code. The image processing server 102 then transfers the content data including the processed image data and text data to the data server 103 together with the job attributes.

The data server 103 sequentially stores the content data and job attributes transferred from the image processing server 102 as a job log. The job log includes a bibliographic log and a print log.

A device driver for transferring a print job to the digital MFP 101 is installed in a storage device of the user PC104. The administrator PC105 can be connected to the digital MFP 101, the image processing server 102, and the data server 103. Operating systems (OS) installed in each of the administrator PC 105 and the user PC 104 perform various data processing and communication by executing applications. Further, as the information processing apparatuses, the administrator PC 105 and the user PC 104 each includes a controller unit including a central processing unit (CPU), a read-only memory (ROM), and a random access memory (RAM), an input device such as a keyboard or a mouse, and an output device such as a display apparatus.

FIG. 2 is a block diagram illustrating a configuration of processing units in the digital MFP 101 and the image processing server 102 illustrated in FIG. 1.

Referring to FIG. 2, a job attribute acquisition unit 201 acquires job attributes from a job which is implemented in the digital MFP 101. In particular, the job attribute acquisition unit 201 acquires codes which are set to the job hand a “job owner” (i.e., a user name who executes the job). The job attributes acquired by the job attribute acquisition unit 201 are stored in a storage device 206 by a job attribute storing unit 202. The storage device 206 is configured of a non-volatile memory.

A user authentication unit 203 authenticates whether the user using the digital MFP 101 is registered as a permitted user. Further, the user authentication unit 203 can designate a code to be set to the job transferred to the digital MFP 101.

More specifically, the user authentication unit 203 displays, for example, a dialog for inputting the user name and a password on an operation panel as a UI and prompts the user to input the user name and the password. When the user inputs the user name and the password on the operation panel, the user authentication unit 203 transmits the input user name and password to an authentication server (such as Active Directory, not illustrated) and performs authentication. A permitted user is thus identified from the authentication result.

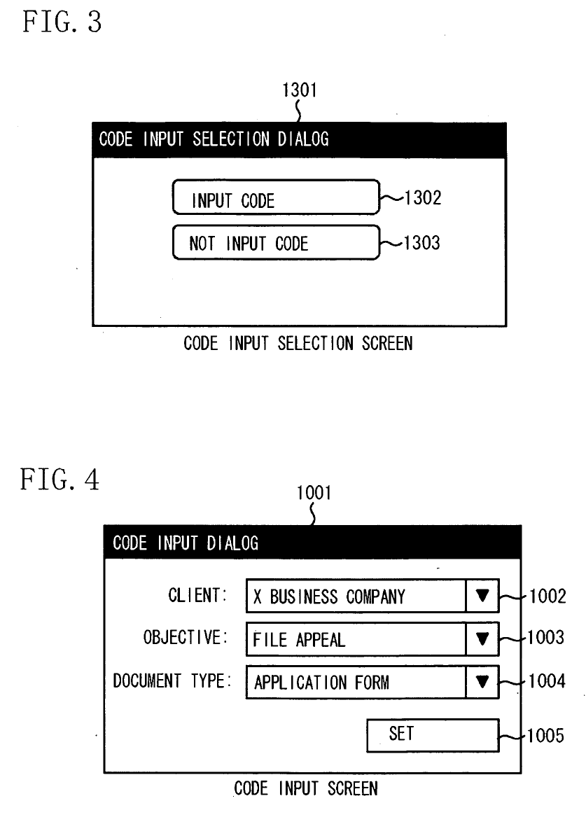

The user authentication unit 203 then displays a code input selection dialog illustrated in FIG. 3 and causes the user to select whether to input the code. Since dialogs illustrated in FIGS. 3 and 4 are also displayed by the printer driver of the user PC 104 as will be described below, the dialogs will be described for both the MFP 101 and the user PC 104 in the present exemplary embodiment.

FIG. 3 illustrates an example of a UI 1301 displayed on the operation panel of the digital MFP 101 illustrated in FIG. 1. More specifically, FIG. 3 illustrates an example of the dialog displayed as a process performed by the user authentication unit 203.

Further, if the user selects an “input code” button 1302 on the UI 1301 illustrated in FIG. 3, the user authentication unit 203 performs control to display a code input dialog illustrated in FIG. 4. The user can then designate the code.

Referring to FIG. 3, the UI 1301 which is the dialog for the user to select code input, is displayed by the printer driver in the user PC 104 or by the user authentication unit 203 in the digital MFP 101. There is no limitation on a configuration of an application regarding the display.

When the user presses the “input code” button 1302, the code input dialog illustrated in FIG. 4 is displayed for the user to input the code.

The user presses a “not input code” button 1303 to designate not to input the code. In this case, the code input dialog is not displayed, and the code is not set to the job or the login context.

In the present exemplary embodiment, the code input selection dialog is provided to specifically indicate whether the user is to input the code. However, it is possible to determine that the user does “not input code” if the user presses a set button 1005 in the dialog illustrated in FIG. 4 without inputting the code. Otherwise, choices whether to input the code or not can be displayed on other screens of the printer driver such as a print setting screen.

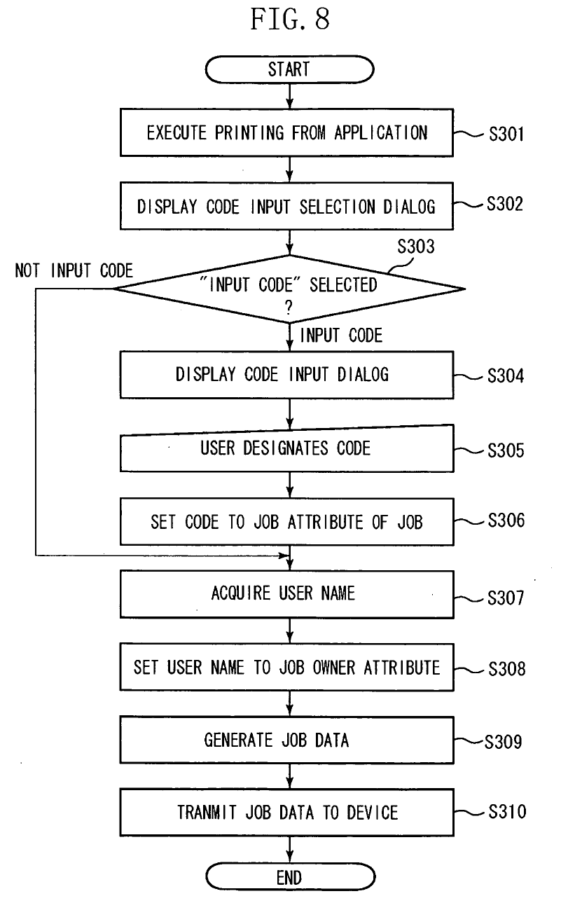

FIG. 4 illustrates an example of a UI 1001 displayed on the operation panel of the digital MFP 101. More specifically, the UI 1001 is a dialog prompting the user to input three codes. However, a number of codes is not limited to three. Such codes are referred to as billing codes that function as information for specifying attributes that indicate a type of a print document to be processed by the digital MFP 101. The dialogs illustrated in FIGS. 3 and 4 are also displayed by the printer driver installed in the user PC 104 as illustrated in the flowchart of FIG. 8. In the present exemplary embodiment, history information of the processed print document is registered in the data server 103 according to the contents of the above-described codes set to the print document, which is different from normal processing of a print document. Details will be described with reference to FIG. 12.

Referring to FIG. 4, the UI 1001 is the code input dialog and is displayed by the printer driver in the user PC 104 or the user authentication unit 203 in the digital MFP 101.

There is no limitation on a configuration of an application regarding the display.

Controls 1002, 1003, and 1004 are used to designate the codes for each layer. In the example illustrated in FIG. 4, the user designates a “client” by the control 1002, and an “objective” by the control 1003. The codes to be designated using the controls 1002, 1003, and 1004 are not limited to the above-described examples. An administrator can appropriately determine print document attributes to be designated, such as an image or a text, bit configuration of color, resolution, image quality, presence or absence of a signature and a time stamp, and a data format. In a case of the bit configuration of color, the code can be designated such as 1 bit as monochrome, 8 bits as grayscale, and 24 bits as color. Further, the resolution such as 100 dpi, 200 dpi, and 300 dpi can be designated.

Further, the user can designate the image quality by a compression ratio of a quality (Q) factor of a joint photographic experts group (JPEG). The user can also designate the data format by a JPEG format or a page description format (PDF).

The user uses the control 1004 to select a code designating a “document type”. As described above, the code can be designated for each layer. When the user presses the set button 1005 to confirm the designation, the codes input for each layer are determined, and the process proceeds to the next step. The configuration of the above-described UI is an example of a code input screen, and items and a position and design of the items are not limited to the above.

As described above, the present exemplary embodiment describes an example in which the “client”, “objective”, and “document type” are assigned as the attributes to indicate the type of the print document. The number and contents of billing codes can be set as appropriate according to a management target of the administrator.

In the example of the code input dialog illustrated in FIG. 4, the user has selected “X business company” for the “client”, “file appeal” for the “objective”, and “application form” for the “document type”, as billing codes.

Returning to FIG. 2, a job generation unit 204 generates a job such as a copy job according to a user instruction. The job generation unit 204 further acquires a name of the authenticated user and the input billing codes from the user authentication unit 203 and sets the acquired information to the job.

An image data storing unit 205 stores the image data generated when the job is executed, associated with the job attributes in the storage device 206. An image data transfer unit 207 transfers a group of image data stored in the storage device 206 to the image processing server 102 at a time set by a system administrator, or at constant intervals.

In the image processing server 102 illustrated in FIG. 2, an image data receiving unit 208 receives the image data transmitted from the image data transfer unit 207 in the digital MFP 101. In the present example, the image data receiving unit 208 receives the image data via the network 110.

If the billing code is set to the received image data as the job attribute, a recording format determination unit 209 checks a content data recording format set to the billing code and determines a process flow according to the content data recording format.

An OCR processing unit 211 performs an OCR process on the image data according to a result of the recording format determination unit 209 and extracts text data. The extracted text data is associated with the image data.

An image conversion unit 212 performs the resolution conversion and the color conversion on the image data according to the result of the recording format determination unit 209. A data transmission unit 213 transfers the image data processed by the image conversion unit 212 and the text data to the data server 103.

The present exemplary embodiment does not describe a processing unit in the digital MFP 101 that generates basic electronic data of a job when printing is performed. Description of other processes that are not related to the present invention will be similarly omitted.

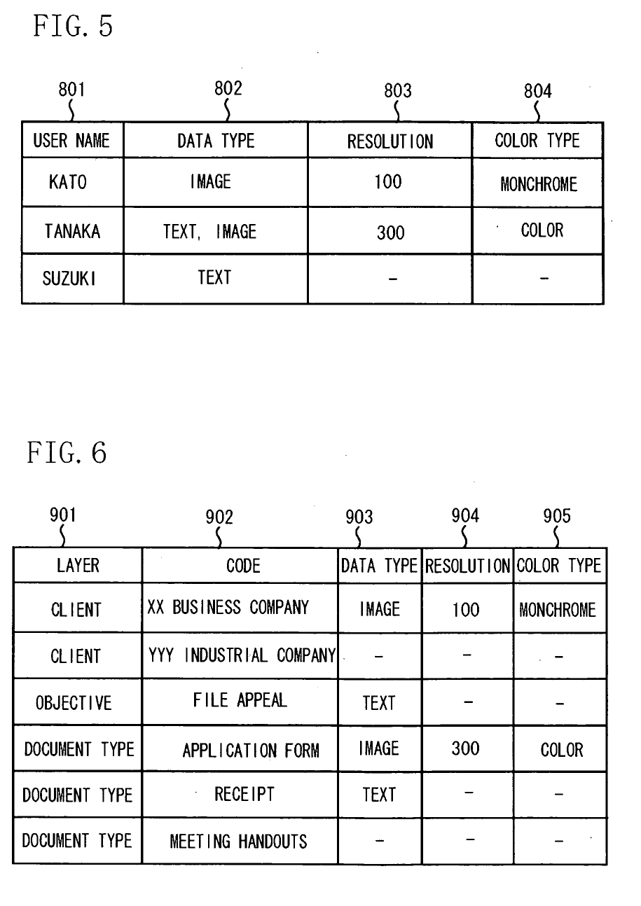

FIG. 5 illustrates an example of a user-content recording format setting table which stores content recording formats for each user that are managed by the image processing server 102. The table is managed by the image processing server 102.

Referring to FIG. 5, a user name column 801 indicates a user of the content recording format setting described in each corresponding line. When a content data recording format of a job is to be determined, reference is made to the line with the user name that matches the job owner name set to the job attributes of the job. In the present example, the user name is a bibliographic item.

A data type column 802 including values such as “image data”, “text”, and “image data and text” indicates the format of content data to be recorded as the history information.

A resolution column 803 including values such as “300 dpi”, “200 dpi”, and “100 dpi” indicates the resolution of the image data to be recorded and is designated when the image data is recorded as the history information.

A color type column 804 including values such as “color”, “grayscale”, and “monochrome” indicates the color type of the image data to be recorded and is designated when the image data is recorded as the history information.

In the table illustrated in FIG. 5, a content recording format of a user “Kato” is “image”, “100 dpi”, and “monochrome”.

Further, a content recording format of a user “Tanaka” is “text and image”, “300 dpi”, and “color”. The content recording formats are thus different for each user. In the present example, a log level of the user “Tanaka” is set higher than that of the user “Kato” to record detailed history information.

The above-described management system in the present exemplary embodiment extracts a portion of setting items among other setting items and is not limited to the above-described items.

FIG. 6 illustrates a code-content recording format setting table which stores content recording formats that correspond to each code which is managed by the image processing server 102 illustrated in FIG. 1. In the present exemplary embodiment, each code has three layers, i.e., “client”, “objective”, and “document type”, and is managed for each layer. However, this is not a limitation. The table is managed by the image processing server 102.

Referring to FIG. 6, a code in each line belongs to a code layer indicated in a code layer column 901.

A code column 902 indicates the code that corresponds to the content recording format setting of each line. A data type column 903 is similar to the data type column 802 illustrated in FIG. 5. A resolution column 904 is similar to the resolution column 803, and a color type column 905 is similar to the color type column 804 illustrated in FIG. 5.

In the example illustrated in FIG. 6, a job whose document type layer is an “application form” is an important document, so that the image data is designated to be recorded at the resolution of 300 dpi and in color.

On the other hand, a job whose document type layer is a “receipt” is a document of less importance or in which only text information is sufficient, so that only the text data is designated to be recorded.

The above-described management system in the present exemplary embodiment extracts a portion of setting items among other setting items and is not limited to the above-described items.

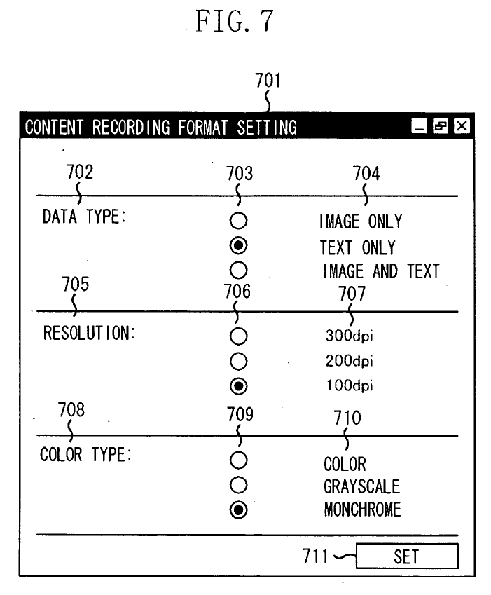

FIG. 7 illustrates an example of a UI displayed on the administrator PC 105 illustrated in FIG. 1. More specifically, the example illustrates a UI used by the system administrator to set a content recording format that corresponds to a user or a code. When the system administrator designates a user or a code and activates a screen for setting the content recording format, a content recording format setting screen 701 is displayed.

Referring to FIG. 7, the content recording format setting screen 701 is displayed on the administrator PC 105. A configuration of the application is not limited. A data type setting portion 702 is used to set a data type, as indicated by the title displayed on the left side of the setting portion.

Radio buttons 703 each corresponds to a data type name 704. There are three radio buttons in the present exemplary embodiment. The data type selected using the radio buttons 703 is set as a value in the data type column 802 illustrated in FIG. 5 and the data type column 903 illustrated in FIG. 6.

A resolution setting portion 705 is used to set the resolution of the image data as indicated by the title displayed on the left side of the setting portion. Radio buttons 706 each corresponds to a resolution 707. There are three radio buttons in the present exemplary embodiment. The resolution selected using the radio buttons 706 is set as a value in the resolution column 803 illustrated in FIG. 5 and the resolution column 904 illustrated in FIG. 6.

A color type setting portion 708 is used to specify the color setting of the image data as indicated by the title displayed on the left side of the setting portion. Radio buttons 709 each corresponds to a color type 710. There are three radio buttons in the present exemplary embodiment. The color type selected using the radio buttons 709 is set as a value in the color type column 804 illustrated in FIG. 5 and the color type column 905 illustrated in FIG. 6.

When the user presses a set button 711, the settings selected as described above are reflected on the designated content recording format setting table based on users or codes.

The above-described UI in the management system in the present exemplary embodiment extracts a portion of setting items among other setting items and is not limited to the above-described items.

FIG. 8 is a flowchart illustrating an example of a data processing procedure in the information processing apparatus according to the exemplary embodiment of the present invention. More specifically, the flowchart illustrates a process performed by the user PC 104 when a print document is printed using the printer driver. The CPU included in the user PC 104 realizes each step of the flowchart by loading a control program in the RAM and executing the control program under the management of the OS.

In step S301, a user instructs printing from the application. In step S302, the printer driver displays a UI that corresponds to the code input selection dialog illustrated in FIG. 3.

In step S303, the printer driver determines whether the user has selected the “input code” button 1302 on the code input selection dialog.

If the printer driver determines that the user has selected the “input code” button 1302 (INPUT CODE in step S303), the process proceeds to step S304. In step S304, the printer driver displays the code input dialog illustrated in FIG. 4 as a pop up.

In step S305, if the printer driver determines that the user selects registered items using the controls 1002, 1003, and 1004 and presses the set button 1005, the process proceeds to step S306.

Returning to step S303, if the printer driver determines that the user has selected “not input code” button 1303 (NOT INPUT CODE in step S303), the code input and setting processes are skipped, and the process proceeds to step S307. In this case, the code is not designated, and the content recording format is determined based on the job owner (user name) by a context recording format determination process to be described below.

In step S306, the printer driver sets a pair of the billing code and the corresponding layer that the user designated via the dialog illustrated in FIG. 4, to a job attribute of the job.

In step S307, the printer driver acquires the name of the user who performed printing from the application.

In step S308, the printer driver sets the acquired user name as a job owner attribute of the job.

In step S309, the printer driver converts a rendering instruction from the application and generates job data.

In step S310, the printer driver transmits the job data to a device via a spooler and a port monitor. The process then ends.

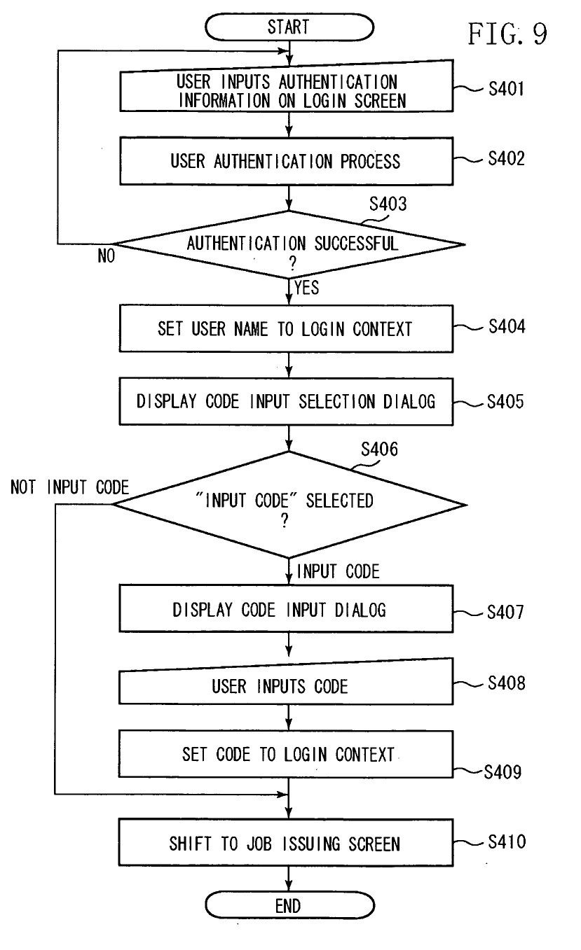

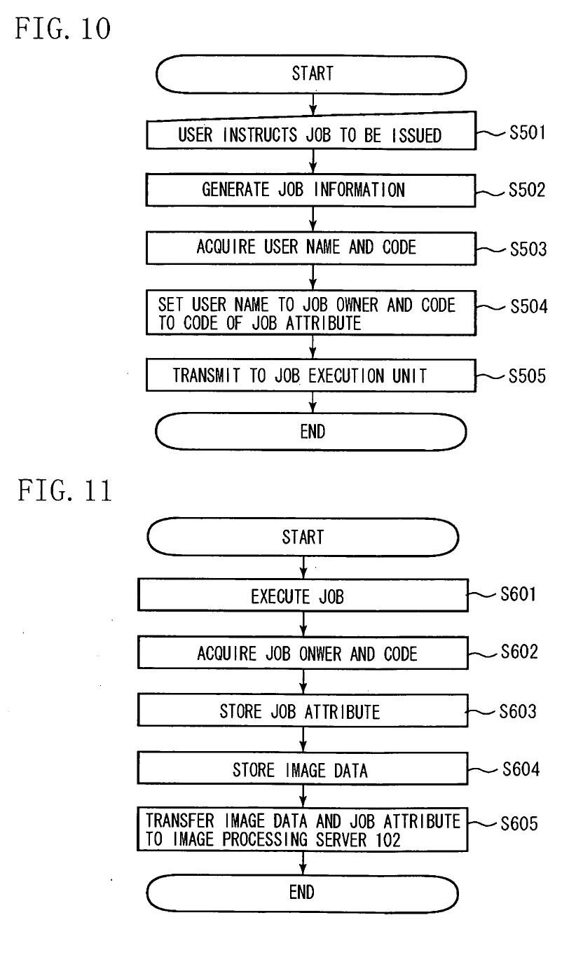

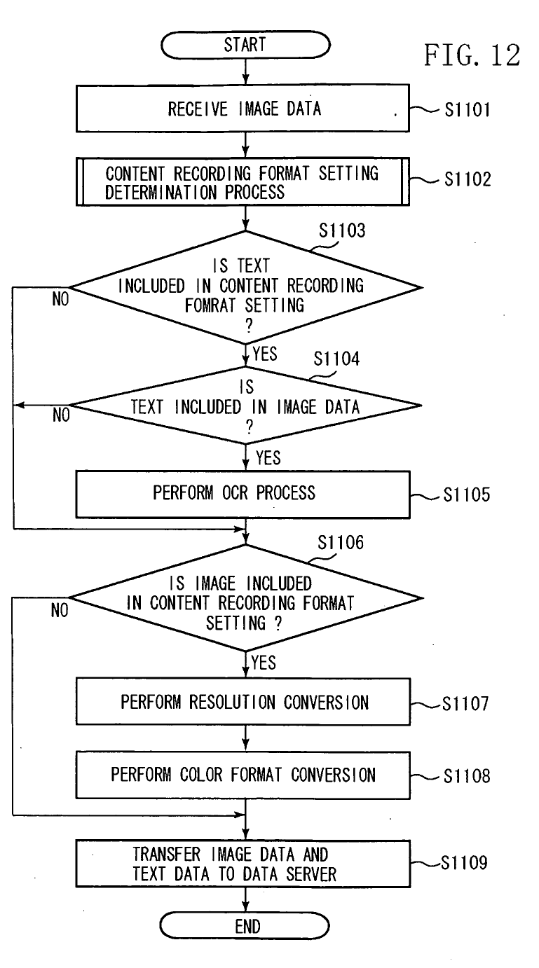

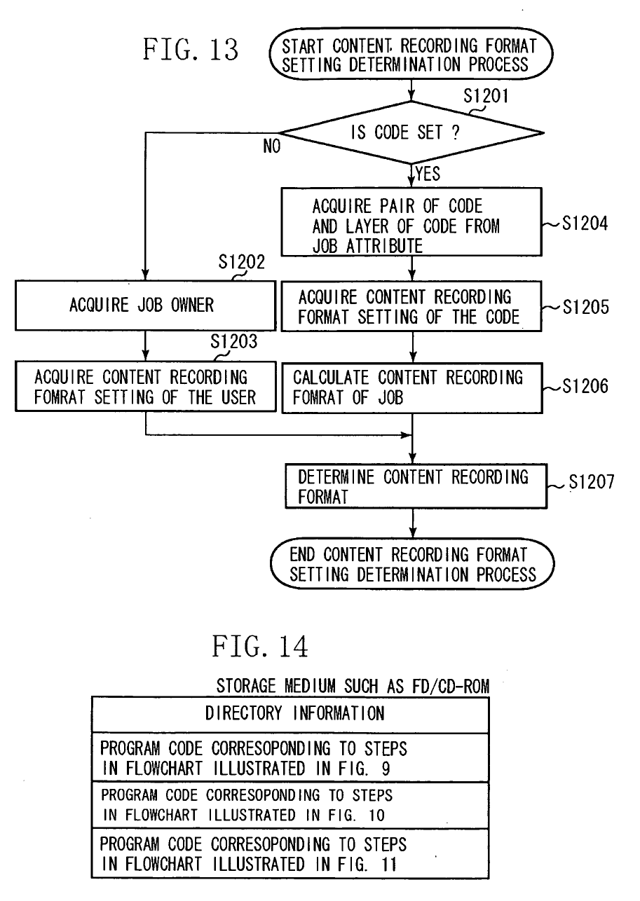

FIG. 9 is a flowchart illustrating the data processing procedure in the image forming apparatus according to the exemplary embodiment of the present invention. More specifically, the flowchart illustrates a process performed in the digital MFP 101 when the user logs in the image forming apparatus and designates a code. The CPU in the digital MFP 101 realizes each step of the flowchart by executing the user authentication unit 203.

In step S401, the user inputs authentication information, such as a user name and a password, on a login screen displayed on the operation panel of the digital MFP 101.

In step S402, the user authentication unit 203 performs an authentication process on the user information input by the user on the login screen displayed in step S401 using an authentication system (not illustrated).

In step S403, the user authentication unit 203 determines whether the user authentication performed in step S402 is successful. If the user authentication unit 203 determines that the user authentication failed (NO in step S403), the process returns to step S401, and the user authentication unit 203 displays the login screen.

On the other hand, if the user authentication unit 203 determines that the user authentication is successful (YES in step S403), the process proceeds to step S404. In step S404, the user authentication unit 203 sets the user name in the login context.

In step S405, the user authentication unit 203 displays the code input selection dialog illustrated in FIG. 3 on the operation panel of the MFP 101.

In step S406, the user authentication unit 203 determines whether the user has selected the “input code” button 1302 on the code input selection dialog. If the user authentication unit 203 determines that the user has selected the “input code” button 1302 (INPUT CODE in step S406), the process proceeds to step S407. In step S407, the user authentication unit 203 displays the code input dialog illustrated in FIG. 4 as a pop up.

On the other hand, if the user authentication unit 203 determines that the user has selected the “not input code” button 1303 (NOT INPUT CODE in step S406), the code input and setting processes are skipped, and the process proceeds to step S410. In this case, the code is not designated, and the code recording format is determined based on the job owner (user name) by the context recording format determination process to be described below.

In step S407, the user authentication unit 203 displays the code input dialog illustrated in FIG. 4.

In step S408, the user designates and inputs a billing code in the code input dialog and presses the set button 1005. The process proceeds to step S409.

In step S409, the user authentication unit 203 sets a pair of the designated code and the corresponding layer to the login context.

In step S410, the authentication process ends, and the screen shifts to a job issue screen such as a copy screen.

FIG. 10 is a flowchart illustrating the data processing procedure in the image forming apparatus according to the exemplary embodiment of the present invention. More specifically, the flowchart illustrates a process performed in the digital MFP 101 when a job is issued. The CPU in the digital MFP 101 realizes each step of the flowchart by executing the job generation unit 204.

In step S501, the user instructs issuance of a job such as a copy job via a UI displayed on the operation panel of the MFP 101.

In step S502, the job generation unit 204 generates job information.

In step S503, the job generation unit 204 acquires the login context from the user authentication unit 203 and acquires the user name set in the login context and the codes of each layer set in the code input dialog illustrated in FIG. 4.

In step S504, the job generation unit 204 sets the user name to the job owner of the job attribute and the acquired code to the code of the job attribute.

In step S505, the job generation unit 204 transmits the job to a job execution unit (not illustrated), and the process thus ends.

FIG. 11 is a flowchart illustrating the data processing procedure in the image forming apparatus according to the exemplary embodiment of the present invention. More specifically, the flowchart illustrates a process performed by the job attribute acquisition unit 201, the job attribute storing unit 202, the image data storing unit 205, and the image data transfer unit 207 in the digital MFP 101 when a job is executed. The CPU in the digital MFP 101 realizes each step of the flowchart by executing the job generation unit 204, the job attribute storing unit 202, and the image data storing unit 205.

In step S601, after the job execution unit receives the job from the job generation unit 204, printing is performed according to conditions set to the job.

In step S602, the job attribute acquisition unit 201 acquires at least information about the job owner and the code of each layer from the job attributes set to the job. If the user selects “not input code” in step S303 illustrated in FIG. 8 and in step S406 illustrated in FIG. 9, the code is not designated, so that the code cannot be acquired.

In step S603, the job attribute storing unit 202 stores the job attributes acquired by the job attribute acquisition unit 201 in the storage device 206.

In step S604, the image data storing unit 205 stores the image data in the storage device 206.

In step S605, the image data transfer unit 207 transfers the image data stored in the storage device 206 and the job attributes including at least the information about the job owner and the code of each layer to the image processing server 102. The process then ends.

FIG. 12 is a flowchart illustrating a data processing procedure in a management server according to the exemplary embodiment of the present invention. More specifically, the flowchart illustrates a content data generation process performed by the image processing server 102 illustrated in FIG. 1. The flow is a series of processes performed by the image data receiving unit 208, the recording format determination unit 209, the OCR processing unit 211, the image conversion unit 212, and the data transferring unit 213 illustrated in FIG. 2.

In step S1101, the image data receiving unit 208 in the image processing server 102 receives the image data transferred from the digital MFP 101.

In step S1102, the recording format determination unit 209 executes a content recording format determination process and determines the content recording format, which will be described in detail below.

In step S1103, the recording format determination unit 209 determines whether a text is included in the content recording format setting. If the recording format determination unit 209 determines that the text is not included in the content recording format setting (NO in step S1103), the process proceeds to step S1106.

On the other hand, if the recording format determination unit 209 determines that the text is included in the content recording format setting (YES in step S1103), the process proceeds to step S1104.

In step S1104, the OCR processing unit 211 determines whether a text is included in the image data. If the OCR processing unit 211 determines that the image data does not include any text (NO in step S1104), the process proceeds to step S1106. On the other hand, if the OCR processing unit 211 determines that the image data includes the text (YES in step S1104), the OCR processing unit 211 performs the OCR process on the image data and extracts text data in step S1105.

In step S1106, the recording format determination unit 209 determines whether an image is included in the content recording format setting. If the recording format determination unit 209 determines that the image is not included (NO in step S1106), the process proceeds to step S1109.

If the recording format determination unit 209 determines that the image is included (YES in step S1106), the process proceeds to step S1107. In step S1107, the image conversion unit 212 performs the resolution conversion to convert the image to the resolution according to the recording format setting.

In step S1108, the image conversion unit 212 performs the color conversion on the image.

In step S1109, the data transfer unit 213 transfers the image data and the text data to the data server 103 according to the content recording format. The process then ends. If the recording format determination unit 209 determines that the image data or the text is not designated, the data transfer unit 213 informs the data server 103 that there is no image data or text by transferring an empty data.

FIG. 13 is a flowchart illustrating the data processing procedure in the management server according to the exemplary embodiment of the present invention. More specifically, the flowchart illustrates a recording format determination process performed by the image processing server 102 illustrated in FIG. 1. The steps in the flowchart describe an example of a content recording determination process performed by the recording format determination unit 209 illustrated in FIG. 2.

In step S1201, the recording format determination unit 209 determines whether a code is set as the job attributes of the job to the received image data. If the recording format determination unit 209 determines that the code is not set (NO in step S1201), the process proceeds to step S1202. In step S1202, the recording format determination unit 209 acquires the job owner of the job.

In step S1203, the recording format determination unit 209 acquires from the user-content recording format table illustrated in FIG. 5, a content recording format setting of the line whose user name matches the job owner acquired in step S1202. The recording format determination unit 209 determines the content recording format, and the process proceeds to step S1207.

On the other hand, if the recording format determination unit 209 determines that the code is set on the received image data in step S1201 (YES in step S1201), the process proceeds to step S1204, and the recording format determination unit 209 acquires the set code and the layer of the code from the job attributes.

In step S1205, the recording format determination unit 209 acquires from the code-content recording format setting table illustrated in FIG. 6, the content recording format that corresponds to the code acquired in step S1205. If codes with a plurality of layers are designated to the job, the recording format determination unit 209 acquires content recording format settings for each code.

In step S1206, the recording format determination unit 209 calculates a content recording format of the job from the content recording format settings for each code.

In step S1207, the recording format determination unit 209 determines the content recording format. The process then ends.

If the content recording format settings for each code are different in step S1206, the content recording format setting is calculated, for example, by taking a sum of all data types that correspond to each code, and selecting the highest value from resolutions for the content recording format setting of the job. Further, the color type whose amount of information is the greatest is selected as the color type for the content recording format setting of the job (i.e., grayscale is selected preferentially over monochrome, or color is selected preferentially over monochrome or grayscale).

Since the job execution process in the digital MFP 101 and the image conversion process in the image processing server 102 are not essentially related to the present invention, detailed description is omitted.

As described above, the exemplary embodiment of the present invention can solve the problem of a limit on the storage area of the print log by adjusting the log level of the history information according to the print job. More specifically, if the log level is high, a detailed image data which is created in full color at a resolution of 200 dpi is recorded. On the other hand, if the log level is low, an abbreviated image data which is created in monochrome at a resolution of 100 dpi is recorded.

Therefore, a log level is raised for an important job to record a detailed history, and the log level is lowered for a job of less importance, so that the storage capacity of the storage device can be reduced.

According to the above-described exemplary embodiment, a job log is recorded at a log level according to a print user in a normal operation. If a code indicating an objective and a document type is set to the job, the job log can be recorded at the log level according to the code.

In the above-described exemplary embodiment, a print log level of a print document is determined using billing codes illustrated in FIG. 4. The print log level can be determined according to a user who performs printing.

For example, a print log level of a user who is previously registered in a specific user file, or a user who is recognized as not having performed normal printing in the past can be raised. Further, a print log level of a print document printed by a temporary employee can be raised.

If the above-described billing code is not designated to a job, the print log can be managed at the print log level that corresponds to the print user. On the other hand, if a “client” (client name) is designated in the billing code of the job, the print log can be managed at the log level that corresponds to the “client”.

Further, if the “client” (client name) and a “matter” (such as work content or document type) are designated in the billing codes of the job, the print log can be managed at the log levels that correspond to the “client” and the “matter”.

Further, if the print log level is not set to the billing code, the print document can be managed according to the print log level of the user. As a result, an accuracy of archive data can be raised (for important data) or lowered in a case of a specific client or a document.

In another exemplary embodiment of the present invention, a part of elements in a print log level (such as resolution and presence or absence of a signature) can be designated for each billing code. The print log level can then be determined by a combination of the partly-designated elements if a plurality of billing codes is designated.

For example, in a case where the billing codes are set as “X business company”: “resolution 200”, “application form”: “with signature”, the print log is managed by “resolution 200” and “with signature” when “X business company” and “application form” are designated.

In another exemplary embodiment of the present invention, if the print log level is different for each billing code, the print log level can be determined by giving priority to the billing code of a higher layer or a lower layer. For example, if the layer is higher in the order of the “client”, the “objective”, and the “document type”, the print log can be managed by a print log level designated to the “client”.

Further, if the print log level is different for each billing code, the print log level can be determined according to the print log level indicating a higher resolution, presence of a signature, or presence of a time stamp.

Similarly, an order of priority can be previously assigned to setting values, and the print log level that belongs to the setting value with higher priority can be selected. For example, if a print document with a signature has higher priority, the print log can be managed by the print log level of the signature.

As described above, different print log levels can be set to print documents using billing codes in which attributes indicating a type of the print document are managed by a hierarchical structure.

More specifically, elements, such as a resolution, presence or absence of a signature, or presence or absence of a time stamp, are designated to attributes indicating a type of a print document to be managed. As a result, a print log can be accumulated and managed at a print log level adapted to the objective and content of the print document.

Configurations of data processing programs that are readable by the image forming apparatus, the management apparatus, and the information processing apparatus according to the exemplary embodiment of the present invention will be described below with reference to FIGS. 14, 15, and 16.

FIG. 14 illustrates a memory map of a storage medium which stores various data processing programs that can be read by the image forming apparatus according to the exemplary embodiment of the present invention.

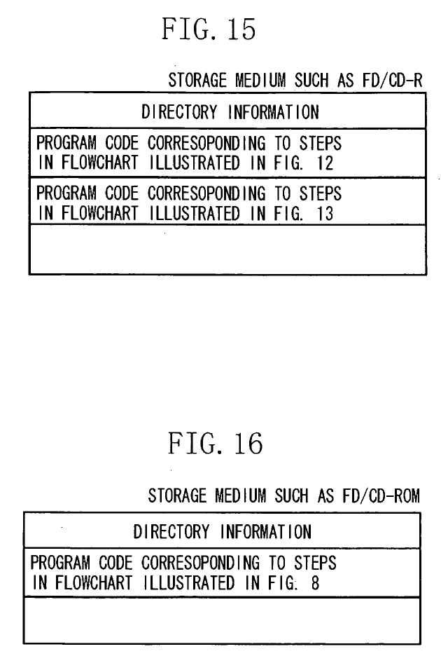

FIG. 15 illustrates a memory map of a storage medium which stores various data processing programs that can be read by the management apparatus according to the exemplary embodiment of the present invention.

FIG. 16 illustrates a memory map of a storage medium which stores various data processing programs that can be read by the information processing apparatus according to the exemplary embodiment of the present invention.

Further, information (not illustrated) for managing program groups stored in the storage medium, such as version information and creator can be stored in the storage medium. Further, information (not illustrated) that depends on an OS which reads a program, such as an icon for identifiably displaying a program, can be stored in the storage medium.

Further, dependent data of various programs are managed in a directory. Further, a program for installing various programs to a computer, or a program for decompressing a compressed program to be installed can be stored in the storage medium.

Functions illustrated in FIGS. 8 to 13 in the above-described exemplary embodiments can be realized by a host computer executing a program installed from an external source. In such a case, the present invention is applicable if an information group including the program is supplied to an output apparatus from a storage medium such as a CD-ROM, flash memory, or a floppy disk (FD), or an external storage medium via a network.

The present invention can also be achieved by providing a computer-readable storage medium which stores software (program code) for implementing the functions of the above-described exemplary embodiments to a system or an apparatus. The software (program code) stored in the storage medium can be read and executed by a computer (central processing unit (CPU) or micro-processing unit (MPU)) of the system or the apparatus.

In this case, the program code read from the storage medium itself realizes the functions of the above-described exemplary embodiments using the computer. The program code itself and the storage medium which stores the program code constitute an embodiment of the present invention.

A computer executable program to implement the above-mentioned exemplary embodiments can take any form, for example, an object code, a program executed by an interpreter, or script data supplied to an operating system (OS) as long as it has the functions of the program.

The storage medium can be, for example, a floppy disk, a hard disk, an optical disk, a magneto-optical disk (MO), a CD-ROM, a CD-recordable (CD-R), a CD-rewritable (CD-RW), a magnetic tape, a nonvolatile memory card, a ROM, or a digital versatile disc (DVD, DVD-ROM, and DVD-R).

In this case, the program code read from the storage medium itself realizes the functions of the exemplary embodiment, and the storage medium storing the program code constitutes the present invention.

The program code can also be supplied by the system or the apparatus accessing a website on the Internet via a browser of a client computer. The program code itself or a compressed file including an auto-install function can be downloaded from the website onto the storage medium such as a hard disk. In addition, the program code can be divided into a plurality of files, and each file can be downloaded from one or more websites. Namely, the present invention can be applied to a World Wide Web (WWW) server and a file transfer protocol (ftp) server that allow numerous users to download the program files so that the functions or processes of the present invention can be realized on their computers.

Furthermore, the program code can be encrypted and stored in a storage medium, such as a CD-ROM, to be distributed to users. A user who satisfies given conditions can download the key information for decrypting the program from a website via the Internet. By using the key information, the encrypted program can be executed and installed in a computer to realize the functions of the present invention.

Furthermore, the above-described exemplary embodiments can be not only realized by executing the program code read by a CPU. An operating system (OS) or the like working on a computer can also perform a part or the whole of processes according to instructions of the program cod) and realize the functions of the above-described exemplary embodiments.

Furthermore, the program code read from a storage medium can be stored in a memory equipped in a function expansion board inserted in a computer or a function expansion unit connected to the computer, and a CPU in the function expansion board or the function expansion unit can execute all or a part of the processing based on the instructions of the program code to realize the functions of the above-described exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-080478 filed Mar. 26, 2008, which is hereby incorporated by reference herein in its entirety.

What is claimed is:

1. A print management system that manages a print log of a print document processed by an image processing apparatus, the print management system comprising:
an image processing apparatus comprising:
a designation unit configured to designate a billing code of the print document; and
a transfer unit configured to transfer the billing code designated by the designation unit and image data generated from the print document to the server; and
a server comprising:
a determination unit configured to determine a log level of the print log that stores the print document based on the billing code received from the image processing apparatus.

2. A print management system that manages a print log of a print document generated by an information processing apparatus, the print management system comprising:
an information processing apparatus comprising:
a designation unit configured to designate a billing code of the print document; and
a transfer unit configured to transfer the billing code designated by the designation unit and image data generated from the print document to an image processing apparatus; and
a server comprising:
a determination unit configured to determine a log level of the print log that stores the print document based on the billing code received from the image processing apparatus.

3. The print management system according to claim 1, wherein the server further includes a storing unit configured to store data that is subjected to image processing at the log level determined by the determination unit and the print log including a bibliographic log that identifies the print document.

4. The print management system according to claim 3, wherein the server further includes an image conversion unit configured to perform image conversion processing on the data received from the image processing apparatus based on the log level determined by the determination unit, and
wherein the storing unit stores the print log including data on which the image conversion unit performs the image conversion processing.

5. A print management system which manages a log level of each user who inputs a print document and manages a print log of the print document processed by an image processing apparatus, the print management system comprising:
an image processing apparatus comprising:
a designation unit configured to designate a billing code of the print document; and
a transfer unit configured to transfer the billing code designated by the designation unit and data generated from the print document to the server; and
a server comprising:
a first determination unit configured to determine whether the billing code is designated to data received from the image processing apparatus; and
a second determination unit configured to determine, if the first determination unit determines that the billing code is designated, a log level of the print log based on the billing code regardless of the log level for each user.

6. A print management system in which a server receives a print document from an information processing apparatus, and which manages a print log of the print document according to a log level set for each user, the print management system comprising:
an information processing apparatus comprising:
a designation unit configured to designate a billing code of the print document; and
a transfer unit configured to transfer the billing code designated by the designation unit and image data generated from the print document to an image processing apparatus; and
a server comprising:
a first determination unit configured to determine whether the billing code is designated to data received from the image processing apparatus; and
a second determination unit configured to determine, if the first determination unit determines that the billing code is designated, a log level of the print log based on the billing code regardless of the log level for each user.

7. The print management system according to claim 6, wherein the second determination unit determines the log level of the print log for each user, if the first determination unit determines that the billing code is not designated.

8. An information processing apparatus which transfers a print document to an image processing apparatus that transfers a print log to a server, the information processing apparatus comprising:
a designation unit configured to designate a billing code of the print document; and
a transfer unit configured to transfer the billing code designated by the designation unit and data generated from the print document to the image processing apparatus.

9. The information processing apparatus according to claim 8, wherein the designation unit includes a user interface on which the billing code of the print document can be designated.

10. A method for controlling a print management system including an image processing apparatus and a server that manages a print log of a print document processed by the image processing apparatus, the method comprising:
designating a billing code of the print document by the image processing apparatus;
transferring, from the image processing apparatus to the server, the designated billing code and data generated from the print document; and
determining, by the server, a log level of the print log that stores the print document based on the billing code received from the image processing apparatus.

11. A method for controlling a print management system including an information processing apparatus and a server that manages a print log of a print document generated by the information processing apparatus, the method comprising:
designating a billing code of the print document by the information processing apparatus;
transferring, from the information processing apparatus to an image processing apparatus, the designated billing code and data generated from the print document; and
determining, by the server, a log level of the print log that stores the print document based on the billing code received from the image processing apparatus.

12. The method according to claim 10, further comprising storing, in a storing unit of the server, data that is subjected to image processing at the determined log level and the print log including a bibliographic log that identifies the print document.

13. The method according to claim 12, further comprising:
performing, by the server, image conversion processing on the data received from the image processing apparatus based on the determined log level; and
storing the print log including data on which the image conversion processing is performed in the storing unit.

14. A method for controlling a print management system that includes a server which manages a log level of each user who inputs a print document and manages a print log of the print document processed by an image processing apparatus, the method comprising:
designating a billing code of the print document by the image processing apparatus;
transferring, from the image processing apparatus to the server, the designated billing code and data generated from the print document; and
determining, by the server, whether the billing code is designated to data received from the image processing apparatus; and
determining, by the server, if it is determined that the billing code is designated, a log level of the print log based on the billing code regardless of the log level for each user.

15. A method for controlling a print management system in which a server receives a print document from an information processing apparatus, and which manages a print log of the print document according to a log level set for each user, the method comprising:
designating a billing code of the print document by the information processing apparatus;
transferring, from the information processing apparatus to an image processing apparatus, the designated billing code and data generated from the print document;
determining, by the server, whether the billing code is designated to data received from the image processing apparatus; and
determining, by the server, if it is determined that the billing code is designated, a log level of the print log based on the billing code regardless of the log level for each user.

16. The method according to claim 15, further comprising determining the log level of the print log for each user by the server, if it is determined that the billing code is not designated.

17. A method for controlling an information processing apparatus which transfers a print document to an image processing apparatus that transfers a print log to a server, the method comprising:
designating a billing code of the print document; and
transferring the billing code and data generated from the print document to the image processing apparatus.

18. The method according to claim 17, further comprising designating the billing code using a user interface on which the billing code of the print document can be designated.

19. A computer-readable storage medium storing a computer-readable process, the computer-readable process causing a computer to perform a method for controlling a print management system including an image processing apparatus and a server that manages a print log of a print document processed by the image processing apparatus, the method comprising:
designating a billing code of the print document by the image processing apparatus;
transferring, from the image processing apparatus to the server, the designated billing code and data generated from the print document; and
determining, by the server, a log level of the print log that stores the print document based on the billing code received from the image processing apparatus.

20. A computer-readable storage medium storing a computer-readable process, the computer-readable process causing a computer to perform a method for controlling a print management system including an information processing apparatus and a server that manages a print log of a print document generated by the information processing apparatus, the method comprising:
designating a billing code of the print document by the information processing apparatus;
transferring, from the information processing apparatus to an image processing apparatus, the designated billing code and data generated from the print document; and
determining, by the server, a log level of the print log that stores the print document based on the billing code received from the image processing apparatus.

21. A computer-readable storage medium storing a computer-readable process, the computer-readable process causing a computer to perform a method for controlling a print management system that includes a server which manages a log level of each user who inputs a print document and manages a print log of the print document processed by an image processing apparatus, the method comprising:
designating a billing code of the print document by the image processing apparatus;
transferring, from the image processing apparatus to the server, the designated billing code and data generated from the print document; and
determining, by the server, whether the billing code is designated to data received from the image processing apparatus; and
determining, by the server, if it is determined that the billing code is designated, a log level of the print log based on the billing code regardless of the log level for each user.

22. A computer-readable storage medium storing a computer-readable process, the computer-readable process causing a computer to perform a method for controlling a print management system in which a server receives a print document from an information processing apparatus, and which manages a print log of the print document according to a log level set for each user, the method comprising:
designating a billing code of the print document by the information processing apparatus;
transferring, from the information processing apparatus to an image processing apparatus, the designated billing code and data generated from the print document;
determining, by the server, whether the billing code is designated to data received from the image processing apparatus; and
determining, by the server, if it is determined that the billing code is designated, a log level of the print log based on the billing code regardless of the log level for each user.

23. A computer-readable storage medium storing a computer-readable process, the computer-readable process causing a computer to perform a method for controlling an information processing apparatus which transfers a print document to an image processing apparatus that transfers a print log to a server, the method comprising:
designating a billing code of the print document; and
transferring the billing code and data generated from the print document to the image processing apparatus.
